(19) United States
(12) Patent Application Publication
(10) Pub. No.: US 2019/0196434 A1
(43) Pub. Date: Jun. 27, 2019

(54) SYSTEM DESIGN SUPPORTING DEVICE, METHOD FOR SUPPORTING SYSTEM DESIGN, AND PROGRAM FOR SUPPORTING SYSTEM DESIGN

(71) Applicant: Mitsubishi Electric Corporation, Tokyo (JP)

(72) Inventors: Akira FUJISAWA, Tokyo (JP); Yusuke KURODA, Tokyo (JP)

(73) Assignee: Mitsubishi Electric Corporation, Tokyo (JP)

(21) Appl. No.: 16/328,728

(22) PCT Filed: Oct. 31, 2016
(86) PCT No.: PCT/JP2016/082341

§ 371 Date: Feb. 27, 2019

(51) Int. Cl. G05B 19/05; G06F 17/50

(52) U.S. Cl. CPC G05B 19/05; G06F 2217/04; G05B 2219/15012; G06F 17/50

(57) ABSTRACT

A system design supporting device includes a file specification receiving unit, a file acquiring unit, and a parameter setting unit. The file specification receiving unit receives specification of a unique device information definition file from a plurality of unique device information definition files stored in the server. The file acquiring unit acquires, from the server, the unique device information definition file whose specification is received by the file specification receiving unit. The parameter setting unit sets a parameter for controlling operation of a unit, on the basis of the unique device information definition file.

### FIELD

The present application relates to a system design supporting device, a controller, a control system, and an operation screen.

### BACKGROUND

There exist technologies for various design supports (refer to, for example, Patent Literature 1). There also exist system design supporting devices for supporting design of factory automation (FA) systems including devices used in the FA for controlling devices operating on a production line of a factory or the like. Referring to a database in which unique device information definition files of FA devices supported by the system design supporting device are registered, a user of a system design supporting device performs such an operation as creating a program for a control device that is a FA device.

### CITATION LIST

### Patent Literature

Patent Literature 1: Japanese Patent Application Laid-open. No. 2012-256103

### SUMMARY

### Technical Problem

In the FA, parameters are set for each of control devices such as programmable logic controllers (PLCs), and the parameters are managed on a control-device-by-control-device basis. It is inefficient to manage the parameters on the control-device-by-control-device basis, because of possible changes in the parameter. In contrast, a technology for managing all parameters set for a plurality of computer aided designs (CADs) in a database server is proposed, for example (refer to Patent Literature 1). In the field of FA, however, no method of managing all parameters an a server has been proposed. Even the technology for managing all the set parameters for CADs in a server is applied to the field of FA, various parameters need to be set on the control-device-by-control-device basis, and thus the efficiency of the operation of setting the parameters cannot be improved.

The present invention has been made in view of the above, and an object thereof is to provide a system design supporting device, a controller, a control system, and an operation screen enabling easy management of all parameters together and facilitating setting of the parameters for each control device.

### Solution to Problem

To solve the aforementioned problems and achieve the object, the present invention provides a system design supporting device connected to a server and a controller for communication with the server and the controller. The system design supporting device includes a file specification receiving unit, a file acquiring unit, and a parameter setting unit. The file specification receiving unit receives specification of a unique device information definition file from a plurality of unique device information definition files stored in the server. The file acquiring unit acquires, from the server, the unique device information definition file whose specification is received by the file specification receiving unit. The parameter setting unit sets a parameter for controlling operation of a unit of the controller, on the basis of the unique device information definition file.

### Advantageous Effects of Invention

According to the present invention, the management of all parameters can be easily conducted, and the parameters for each control device can easily be set.

### BRIEF DESCRIPTION OF DRAWINGS

FIG. 1 is a diagram illustrating an example of a configuration of a control system according to a first embodiment.

FIG. 2 is a diagram illustrating an example of a functional configuration of a cloud server according to the first embodiment.

FIG. 3 is a table illustrating a correspondence between unique device information definition files and units according to the first embodiment.

FIG. 4 is a diagram illustrating an example of a hardware configuration of the cloud server according to the first embodiment.

FIG. 5 is a flowchart illustrating an example of processing by the cloud server according to the first embodiment.

FIG. 6 is a flowchart illustrating an example of processing by the cloud server according to the first embodiment.

FIG. 7 is a diagram illustrating an example of functional configurations of system design supporting devices and controllers according to the first embodiment.

FIG. 8 is a diagram illustrating an example of a screen for receiving an input specifying a unique device information definition file according to the first embodiment.

FIG. 9 is a diagram illustrating an example of a hardware configuration of the system design supporting devices according to the first embodiment.

FIG. 10 is a flowchart illustrating an example of processing by the system design supporting devices according to the first embodiment.

FIG. 11 is a diagram illustrating an example of a configuration of a control system according to a second embodiment.

FIG. 12 is a table illustrating association between unique device information definition files, units, and unit IDs according to the second embodiment.

FIG. 13 is a diagram illustrating an example of a functional configuration of a controller according to the second embodiment.

FIG. 14 is a diagram illustrating an example of a system configuration information file according to the second embodiment.

FIG. 15 is a diagram illustrating an example of a hardware configuration of a controller according to the second embodiment.

FIG. 16 is a diagram illustrating an example of a hardware configuration of a controller according to the second embodiment.

FIG. 17 is a flowchart illustrating an example of processing of a controller according to the second embodiment.

FIG. 18 is a diagram illustrating an example of a configuration of a control system according to a third embodiment.

FIG. 19 is a diagram illustrating an example of a functional configuration of a cloud server according to the third embodiment.

FIG. 20 is a diagram illustrating an example of a functional configuration of a client terminal according to the third embodiment.

FIG. 21 is a diagram illustrating an example of processing by the control system according to the third embodiment.

### DESCRIPTION OF EMBODIMENTS

### First Embodiment

Embodiments of the present invention will now be described with reference to the drawings. Note that the present invention is not limited to the embodiments.

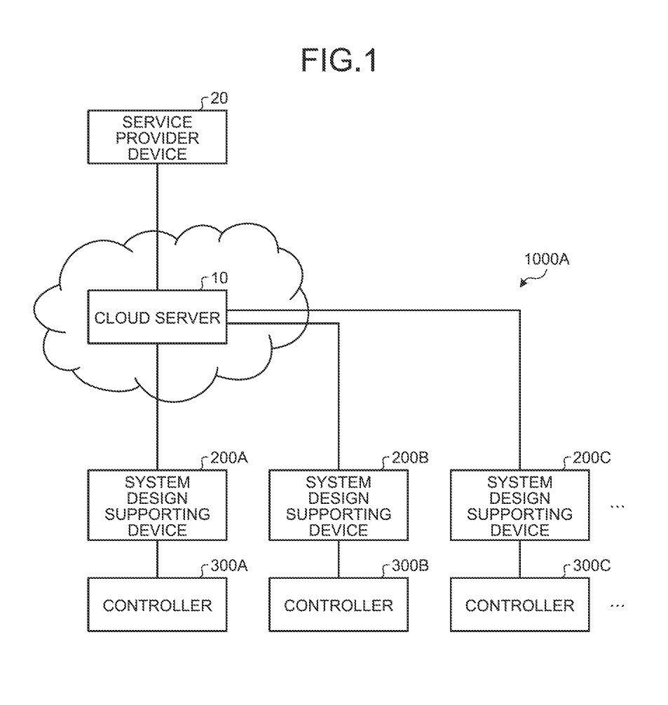

FIG. 1 is a diagram illustrating an example of a configuration of a control system according to a first embodiment. As illustrated in FIG. 1, a control system 1000A according to the first embodiment includes a cloud server 10, a service provider device 20, system design supporting devices 200A, 200B, and 200C, and controllers 300A, 300B, and 300C. The system design supporting device 200A is connected to the cloud server 10 via a network such that the system design supporting device 200A can communicate with the cloud server 10. The system design supporting device 200A is connected to the controller 300A such that the system design supporting device 200A can communicate with the controller 300A. Similarly, the system design supporting device 200B is connected to the cloud server 10 via the network such that the system design supporting device 200B can communicate with the cloud server 10. The system design supporting device 200B is connected to the controller 300B such that the system design supporting device 200B can communicate with the controller 300B. Similarly, the system design supporting device 200C is connected to the cloud server 10 via the network such that the system design supporting device 200C can communicate with the cloud server 10. The system design supporting device 200C is connected to the controller 300C such that the system design supporting device 200C can communicate with the controller 3000. The network may include a local area network (LAN) such as the Internet or Ethernet (registered trademark).

The cloud server 10 according to the first embodiment is placed on a network by a provider of the system design supporting devices 200A, 200B, and 200C (hereinafter referred to as a service provider). The cloud server 10 serve as a computing resource that can be used by users of the system design supporting devices 200A, 200B, and 200C (hereinafter referred to as service users). The cloud server 10 constitutes a so-called cloud computing system (hereinafter referred to as cloud environment) between the cloud server 10 and the system design supporting devices 200A, 200B, and 200C. The cloud server 10 stores unique device information definition files. The unique device information definition files are used in system design, as data available to the service users. The cloud server 10 provides a ubiquitous service that allows the service users to download and use the unique device information definition files as necessary. The cloud environment provided by the service provider achieves a service that allows the service users to acquire a unique device information definition file through a simple operation on a system design supporting device without being aware of the cloud server 10 storing the unique device information definition files. The cloud server 10 is maintained, operated, and managed by the service provider. The service provider operates the service provider device 20 to register and update the unique device information definition files stored in the cloud server 10 as necessary, and constantly manages the unique device information definition files so as to keep the unique device information definition files up-to-date. The unique device information definition files are files in which parameters to be used for controlling units making up controllers such as the controllers 300A, 300B, and 300C are defined. The unique device information definition files may include a variety of information relating to the respective controllers. The information included in the unique device information definition files are, for example, specifications of the units making up the controllers such as the controllers 300A, 300B, and 300C, methods for displaying information unique to the respective units at the respective units, and communication protocols used by the respective units in communication with other devices such as the system design supporting devices 200A, 200B, and 200C. The service provider device 20 is an information processing device operated by the service provider. Although an example in which the cloud server 10 is placed on the network as the computing resource constituting the cloud environment is illustrated in FIG. 1, the cloud environment may be constituted by a plurality of servers capable of processing requests, which are distributed across the servers, from the service users.

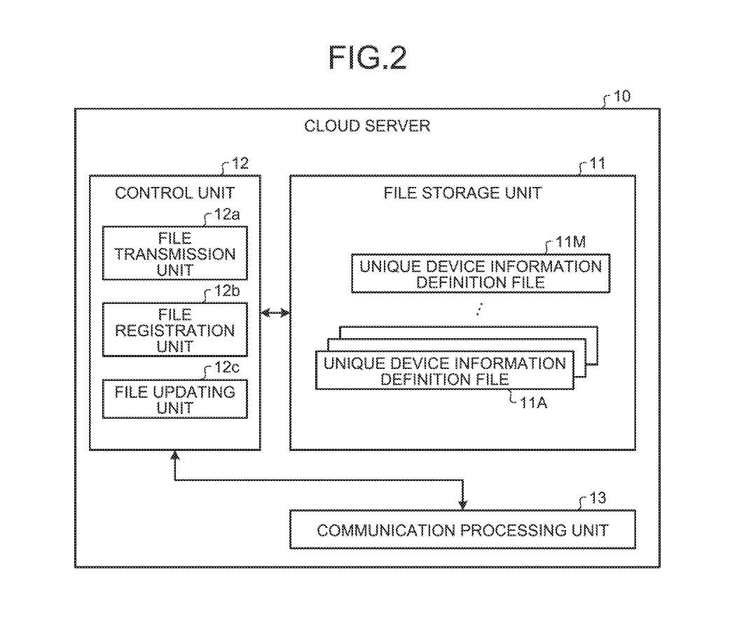

FIG. 2 is a diagram illustrating an example of a functional configuration of the cloud server according to the first embodiment. As illustrated in FIG. 2, the cloud server 10 includes a file storage unit 11, a control unit 12, and a communication processing unit 13.

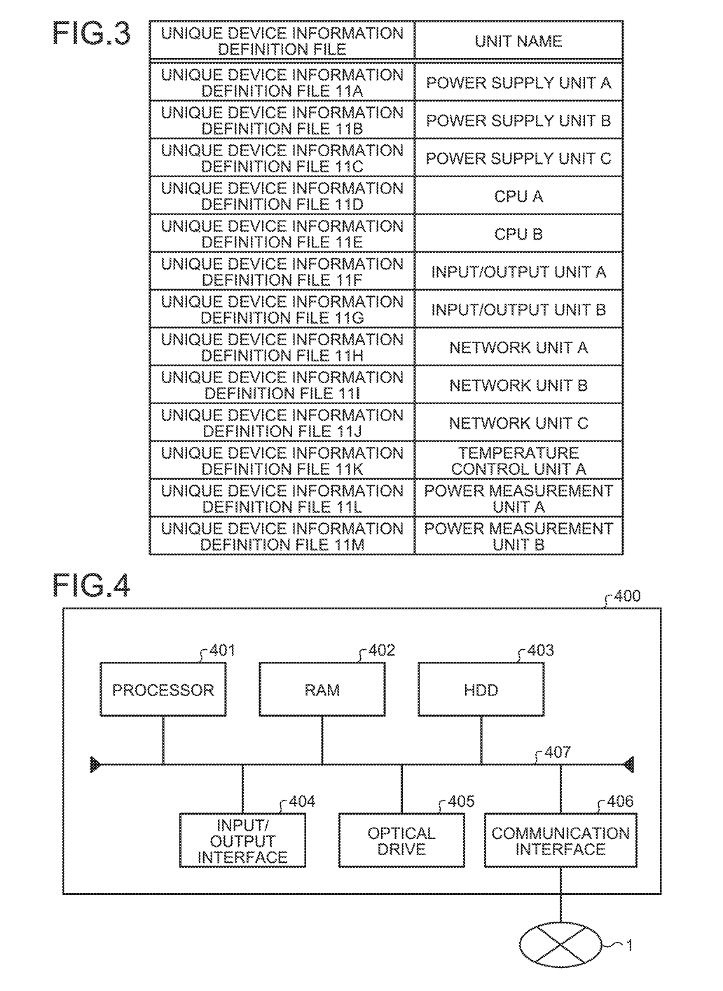

The file storage unit 11 stores unique device information definition files 11A to 11M. The unique device information definition files 11A to 11M have recorded thereon pieces of information that corresponds to one of a plurality of units of the controllers 300A, 300B, and 300C as illustrated in FIG. 3. FIG. 3 is a table illustrating a correspondence between unique device information definition files and units according to the first embodiment.

The control unit 12 performs various controls in the cloud server 10. The control unit 12 includes a file transmission unit 12a, a file registration unit 12b, and a file updating unit 12c. The file transmission unit 12a controls transmission of unique device information definition files to the system design supporting devices 200A, 200B, and 200C via the communication processing unit 13. Specifically, upon receiving from the system design supporting device 200A a request for acquiring a unique device information definition file, the file transmission unit 12a reads from the file storage unit 11 the unique device information definition file corresponding to the received acquisition request. Subsequently, the file transmission unit 12a transmits the unique device information definition file read from the file storage unit 11, to the system design supporting device 200A, which is the source of the acquisition request, via the communication processing unit 13. Upon receiving from the system design supporting device 200B or the system design supporting device 200C a request for acquiring a unique device information definition file, the file transmission unit 12a also performs processing in accordance with the procedures similar to those of the processing that the file transmission unit 12a performs upon receiving from the system design supporting device 200A a request for acquiring a unique device information definition file.

The file registration unit 12b performs processing for registering a unique device information definition file in the file storage unit 11. Upon receiving a file registration request from the service provider device 20, the file registration unit 12b registers, into the file storage unit 11, the unique device information definition file received together with the file registration request. The file updating unit 120 performs processing for updating a unique device information definition file stored in the file storage unit 11. Upon receiving a file updating request from the service provider device 20, the file updating unit 12c identify a unique device information definition file from among a plurality of unique device information definition files stored in the file storage unit 11. The identified unique device information definition file corresponds to the unique device information definition file received together with the file updating request. The file updating unit 120 overwrites and updates the identified unique device information definition file with the unique device information definition file received together with the file updating request, and stores the updated unique device information definition file in the file storage unit 11. The service provider that maintains, operates and manages the unique device information definition files can perform client-server communication and transmit and receive unique device information definition files by using a communication protocol such as transmission control protocol/Internet protocol (TCP/IP). Instead of performing the client-server communication, the service provider may register the unique device information definition files and update the unique device information definition files by remotely operating the cloud server 10 by using teletype network (Telnet), for example.

An example of a hardware configuration of the cloud server 10 will be described with reference to FIG. 4. FIG. 4 is a diagram illustrating an example of a hardware configuration of the cloud server according to the first embodiment. As illustrated in FIG. 4, a computer 400 serving as the cloud server 10 includes a processor 401, a random access memory (RAM) 402, a hard disk drive (HDD) 403, an input/output interface 404, an optical drive 405, a communication interface 406, and a bus 407, for example. The processor 401, the RAM 402, the HDD 403, the input/output interface 404, the optical drive 405, and the communication interface 406 are connected directly or indirectly to one another via the bus 407.

The RAM 402 is a storage device from and into which data can be read and written, and a semiconductor storage device such as a static RAM (SRAM) or a dynamic RAM (DRAM) is used as the RAM 402. A flash memory may be used instead of the RAM 402. The RAM 402 is used as a work area in which results of processing in the controls performed by the processor 401 are temporarily stored. The HDD 403 is a storage device for storing programs and data. The HDD 403 corresponds to, for example, the file storage unit 11 of the cloud server 10.

The input/output interface 404 is an interface connected to an input device and an output device, transmits an input signal from the input device to the processor 401, and performs output to the output device in accordance with an instruction from the processor 401. The optical drive 405 is a device into which an optical disk can be inserted, and which performs reading and writing from/onto the optical disk.

The communication interface 406 is a circuit that controls communication performed via a network 1. The communication interface 406 is a network interface card (NIC), for example. The communication interface 406 corresponds to, for example, the communication processing unit 13 of the cloud server 10.

The processor 401 reads programs stored in the HDD 403, expands the programs into the RAM 402, and executes instructions included in the programs expanded in the RAM 402. The processor 401 operates in accordance with results of execution of instructions included in the programs, thereby implementing, for example, various controls corresponding to the functions provided by the file transmission unit 12a, the file registration unit 12b, and the file updating unit 12c of the control unit 12 of the cloud server 10.

The programs read by the processor 401 from the HDD 403 and the data used in processing performed by the programs are read from the optical disk inserted in the optical drive and stored in the HDD 403. The programs stored in the HDD 403 and the data used in processing performed by the programs may be stored in “another computer (or server)” connected to the computer 400 via a network such as a public line, the Internet, a LAN, or a wide area network (WAN), and the computer 400 may download and execute the programs and data from the computer or server.

The configuration is not limited to the example in which the processor 401 reads and executes programs stored in the HDD 403 to thereby implement, for example, various controls corresponding to the respective functions provided by the control unit 12 of the cloud server 10, as illustrated in FIG. 4. Various controls corresponding to the respective functions provided by the control unit 12 of the cloud server 10 may be implemented by a wired logic including a plurality of processing circuits in cooperation with one another for implementing the controls. For example, application specific integrated circuits (ASICs) or field programmable gate arrays (FPGAs) can be applied to the processing circuits.

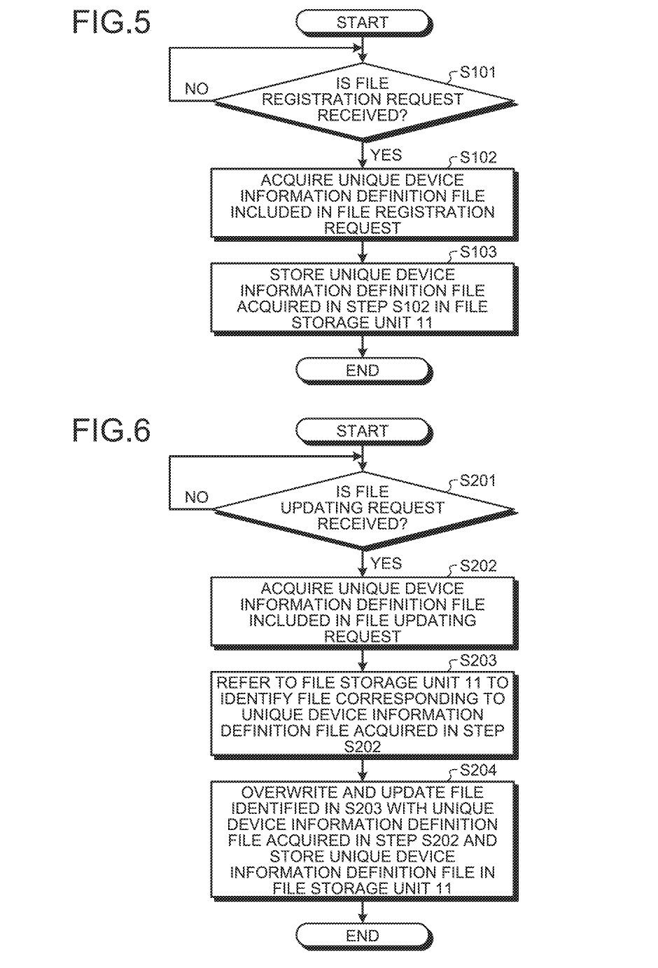

An example of processing performed by the cloud server will be explained with reference to FIGS. 5 and 6. FIGS. 5 and 6 are flowcharts illustrating examples of processing by the cloud server according to the first embodiment.

An example of a file registration process performed by the cloud server 10 will be explained with reference to FIG. 5. As illustrated in FIG. 5, the cloud server 10 determines whether a file registration request is received (step S101). If the result of the determination indicates that no file registration request is received (step S101, No), the cloud server 10 repeats the determination.

if the result of the determination indicates that a file registration request is received (step S101, Yes), the cloud server 10 acquires a unique device information definition file included in the file registration request (step S102).

The cloud server 10 stores the unique device information definition file acquired in step S102, in the file storage unit 11 (step S103), and terminates the process illustrated in FIG. 5.

An example of a file updating process performed by the cloud server 10 will be explained with reference to FIG. 6. As illustrated in FIG. 6, the cloud server 10 determines whether a file updating request is received (step S201). If the result of the determination indicates that no file updating request is received (step S201, No), the cloud server 10 repeats the determination.

If the result of the determination indicates that a file updating request is received (step S201, Yes), the cloud server 10 acquires a unique device information definition file included in the file updating request (step S202).

The cloud server 10 refers to the file storage unit 11 to identify a file corresponding to the unique device information definition file acquired in step S202 (step S203).

The cloud server 10 overwrites and updates the file identified in step S203, with the unique device information definition file acquired in step S202, stores the updated unique device information definition file in the file storage unit 11 (step S204), and terminates the process illustrated in FIG. 6.

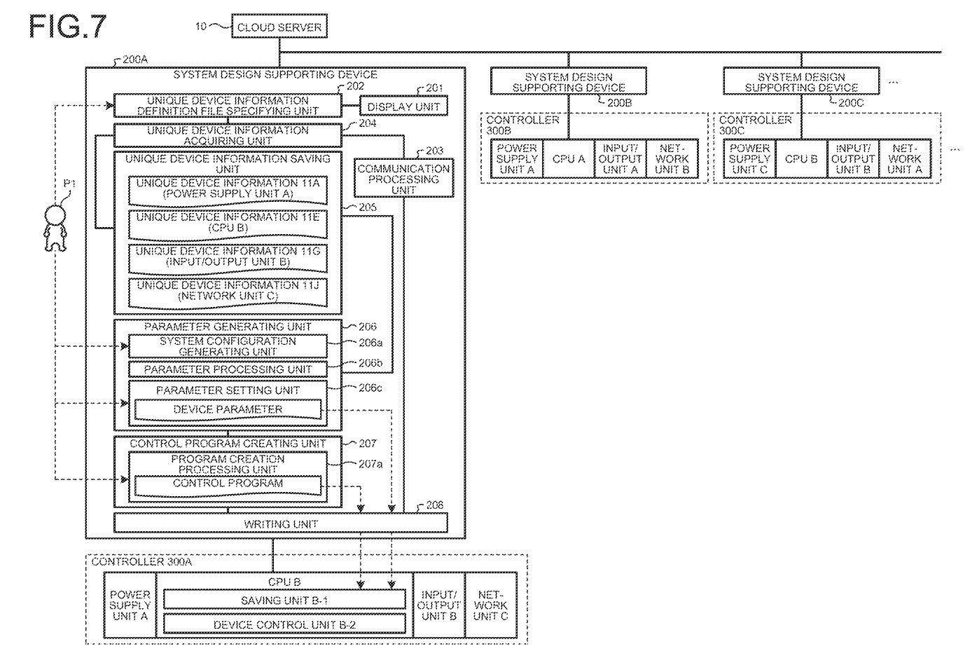

FIG. 7 is a diagram illustrating an example of functional configurations of the system design supporting devices and the controllers according to the first embodiment. Since the system design supporting devices 200A, 200B, and 200C according to the first embodiment have configurations basically similar to one another, the system design supporting device 200A will be taken from among the system design supporting devices 200A, 200B, and 200C and the functional configuration of the system design supporting device 200A will be described below. Since the controllers 300A, 300B, and 300C according to the first embodiment have configurations basically similar to one another, the controller 300A will be taken from among the controllers 300A, 300B, and 300C and part of the functional configuration of the controller 300A will be described below.

As illustrated in FIG. 7, the system design supporting device 200A is connected to the cloud server 10 via the network in a state in which the system design supporting device 200A can communicate with the cloud server 10. The system design supporting device 200A is also connected to the controller 300A in a state in which the system design supporting device 200A can communicate with the controller 300A.

As illustrated in FIG. 7, the system design supporting device 200A includes a display unit 201, a unique device information definition file specifying unit 202, a communication processing unit 203, a unique device information acquiring unit 204, a unique device information saving unit 205, a parameter generating unit 206, a control program creating unit 207, and a writing unit 208. The display unit 201 described below is an example of a display unit. The unique device information definition file specifying unit 202 is an example of a file specification receiving unit. The unique device information acquiring unit 204 is an example of a file acquiring unit. The unique device information saving unit 205 is an example of a storage unit.

The display unit 201 displays a variety of information relating to system design performed by a user P1 of the system design supporting device 200A. The display unit 201 displays a screen that the user P1 uses in performing such operation as specifying a unique device information definition file. The display unit 201 displays a screen that the user P1 uses in setting a system configuration of the controller 300A or the like. The display unit 201 displays a screen that the user P1 uses in creating a control program for the controller 300A.

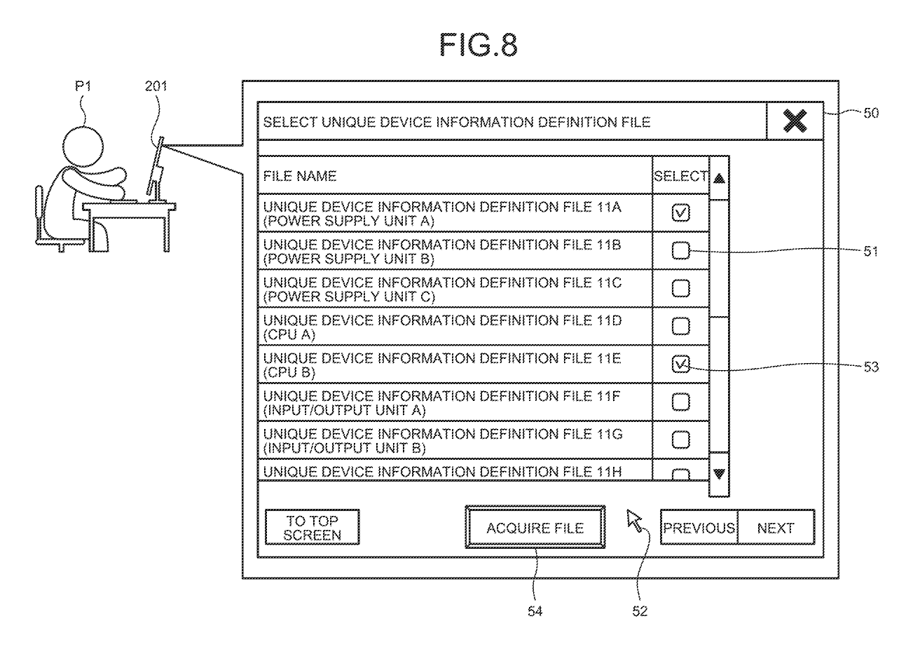

The unique device information definition file specifying unit 202 displays on the display unit 201 a screen for receiving from the user P1 a user's operation of specifying a unique device information definition file. Through the screen displayed on the display unit 201, the unique device information definition file specifying unit 202 receives from the user P1 an input specifying a unique device information definition file. FIG. 8 is a diagram illustrating an example of a screen for receiving an input specifying a unique device information definition file according to the first embodiment. A list of file names of unique device information definition files that can be specified by the user P1 is displayed on a screen 50 illustrated in FIG. 8. The screen 50 includes check boxes 51 for specifying unique device information definition files, a pointer 52 for operating the screen 50, and a file acquisition button 54 for performing acquisition of a specified file. When a check box 51 is operated by the user P1 via the pointer 52, the screen 50 displays a mark 53 informing the user P1 that the unique device information definition file corresponding to the operated check box 51 is specified in the check box 51. The user P1 may again operate the specified unique device information definition file through the pointer 51 such that this specified unique device information definition file becomes unspecified. The screen 50 can delete the mark 53 displayed in the check box 51 in response to the operation of making the specified unique device information definition file unspecified.

While FIG. 8 illustrates an example in which the screen 50 displays some of the file names of the unique device information definition files that can be specified by the user P1, the screen 50 may allow the user P1 to operate a scroll bar to thereby scroll through the area displaying the file names such that the file names of all the specifiable files are displayed on the screen. Alternatively, the screen 50 may display the file names of all the specifiable files. Alternatively, depending on the size or the screen 50, the screen 50 may switch between a scrolling display of the file names of the specifiable unique device information definition files and a display of the file names of all the files.

The communication processing unit 203 controls communication with the cloud server 10 and the controller 300A.

On the basis of the input specifying a unique device information definition file and received by the unique device information definition file specifying unit 202, the unique device information acquiring unit 204 acquires from the cloud server 10 the unique device information definition file corresponding to the received specifying input. Specifically, the unique device information acquiring unit 204 transmits via the communication processing unit 203 to the cloud server 10 a request for acquiring a unique device information definition file corresponding to the specifying input received by the unique device information definition file specifying unit 202. Upon receiving the unique device information definition file from the cloud server 10 via the communication processing unit 203, the unique device information acquiring unit 204 stores the received unique device information definition file in the unique device information saving unit 205. Upon receiving from the writing unit 208 a notification that a writing process is completed, the unique device information acquiring unit 204 deletes the unique device information definition file stored in the unique device information saving unit 205.

The unique device information saving unit 205 stores the unique device information definition file that the unique device information acquiring unit 204 acquires from the cloud server 10.

The parameter generating unit 206 includes a system configuration generating unit 206a, a parameter processing unit 206b, and a parameter setting unit 206c.

The system configuration generating unit 206a performs a system configuration generating process. Specifically, the system configuration generating unit 206a displays on the display unit 201 a screen that is to be used for setting the system configuration of the controller 300A or the like, receives from the user P1 a setting operation and an input of the setting, and generates system configuration information.

On the basis of the unique device information definition file stored in the unique device information saving unit 205, the parameter processing unit 206b performs a process of extracting each item of a parameter that is to be set for each of a plurality of units making up the controller 300A. In the first embodiment, the parameter processing unit 206b extracts the item of the parameter for each of a power supply unit A, a CPU B, an input/output unit B, and a network unit C, all of which make up the controller 300A. Examples of the items of parameters extracted by the parameter processing unit 206b include “allowable voltage” for the power supply unit A and an “IP address” for the network unit C.

The parameter setting unit 206c performs a parameter setting process. Specifically, the parameter setting unit 206c sets a device parameter that is a parameter value input for each item of the parameter that the parameter processing unit 206b extracts for each of the units. The parameter setting unit 206c is an example of a parameter setting unit.

The control program creating unit 207 includes a program creation processing unit 207a. The program creation processing unit 207a displays on the display unit 201 a screen that is to be used for creating a control program for the controller 300A, and creates a control program by compiling source codes written by the user P1.

The writing unit 208 performs a process of writing, in the CPU B of the controller 300A via the communication processing unit 203, the device parameters set by the parameter generating unit 206 and the control program created by the control program creating unit 207. Upon the writing unit 208 completing the writing of the device parameters set by the parameter generating unit 206 into the controller 300A, the unique device information acquiring unit 204 is notified of the completion of the writing.

As illustrated in FIG. 7, the controller 300A includes a power supply unit A, a CPU B, an input/output unit B, and a network unit C. The CPU B includes a saving unit B-1, and a device control unit B-2. The saving unit B-1 stores the control program and the device parameters written by the system design supporting device 200A. Using the control program and the devices parameters stored in the saving unit B-1, the device control unit B-2 controls the operations of the power supply unit A, the input/output unit B, and the network unit C, all of which make up the controller 300A.

The system design supporting device 200B illustrated in FIG. 7 is capable of performing a process of generating system configuration information for the controller 300B, setting device parameters, creating a control program, and writing the device parameters and the control program in the controller 300B, similarly to the system design supporting device 200A. The controller 300B includes a power supply unit A, a CPU A, an input/output unit A, and a network unit B. The system design supporting device 200C illustrated in FIG. 7 is also capable of performing a process of generating system configuration information for the controller 300C, setting device parameters, creating a control program, and writing the device parameters and the control program in the controller 300C, similarly to the system design supporting device 200A. The controller 300C includes a power supply unit C, a CPU B, an input/output unit B, and a network unit A.

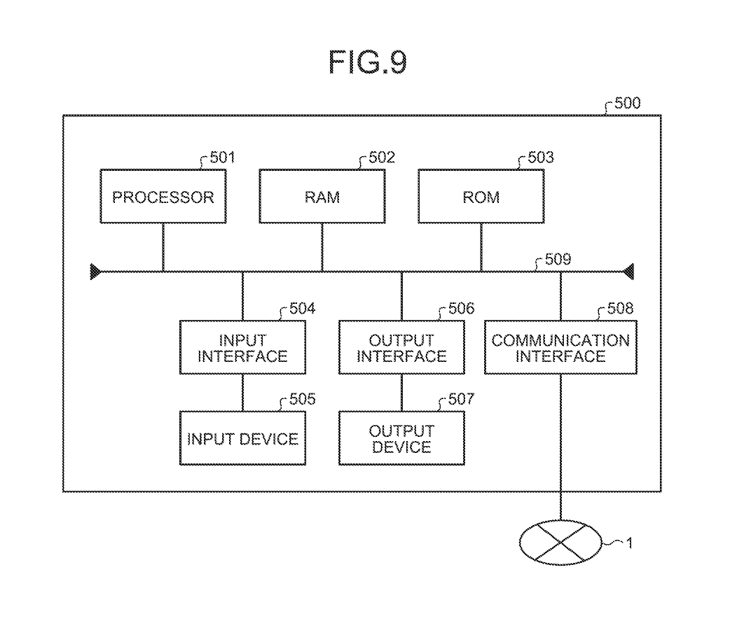

An example of a computer that implements controls similar to various controls of the system design supporting devices illustrated in FIG. 7 will be described with reference to FIG. 9. FIG. 9 is a diagram illustrating an example of a hardware configuration of the system design supporting devices according to the first embodiment.

As illustrated in FIG. 9, a computer 500 serving as a system design supporting device includes, for example, a processor 501, a random access memory (RAM) 502, a read only memory (ROM) 503, an input interface 504, an input device 505, an output interface 506, an output device 507, a communication interface 508, and a bus 509. The processor 501, the RAM 502, the ROM 503, the input interface 504, the input device 505, the output interface 506, the output device 507, and the communication interface 508 are directly or indirectly connected to one another via the bus 509.

The RAM 502 is a storage device from and into which data can be read and written, and a semiconductor storage device such as a static RAM (SRAM) or a dynamic RAM (DRAM) is used as the RAM 502. A flash memory may be used instead of the RAM 502. The RAM 502 is used for a work area in which results of processing in the controls performed by the processor 501 are temporarily stored. The RAM 502 corresponds to the unique device information saving unit 205 of the system design supporting device 200A, for example. The ROM 503 is a storage device from which programs and data can be read, and includes a programmable ROM (PROM). The ROM 503 is used for recording programs and data for implementing various controls performed by the processor 501.

The input interface 504 is a circuit that transmits input signals from the input device 505 to the processor 501. The output interface 506 is a circuit that provides an output for the output device 507 in accordance with an instruction from the processor 501. The communication interface 508 is a circuit that controls communication performed via a network 1. The communication interface 508 is a network interface card (NIC), for example. The input interface 504 and the output interface 506 may be a single integrated unit. The communication interface 508 corresponds to the communication processing unit 203 of the system design supporting device 200A, for example.

The processor 501 reads programs stored in the ROM 503, expands the programs into the RAM 502, and executes instructions included in the programs expanded in the RAM 502. The processor 501 operates in accordance with results of execution of instructions included in the programs, thereby implementing, for example, various controls corresponding to the functions provided by the unique device information definition file specifying unit 202, the unique device information acquiring unit 204, the parameter generating unit 206, the control program creating unit 207, and the writing unit 208 of the system design supporting device 200A.

The programs stored in the ROM 503 and data used in processing performed by the programs need not be initially stored in the ROM 503. For example, the programs for implementing various controls and the data used in processing performed by the programs may be stored in “another computer (or server)” connected to the computer 100 via a network such as a public line, the Internet, a LAN, or a wide area network (WAN), and the computer 500 may download and execute the programs and data from the computer or server.

The configuration is not limited to the example in which the processor 501 reads and executes programs stored in the RCM 503 so that various controls corresponding to the respective functions provided by, for example, the unique device information definition file specifying unit 202, the unique device information acquiring unit 204, the parameter generating unit 206, the control program creating unit 207, and the writing unit 208 of the system design supporting device 200A are implemented as illustrated in FIG. 9. Various controls corresponding to the respective functions provided by the unique device information definition file specifying unit 202, the unique device information acquiring unit 204, the parameter generating unit 206, the control program creating unit 207, and the writing unit 208 may be implemented by a wired logic including a plurality of processing circuits in cooperation with one another for implementing the controls. For example, application specific integrated circuits (ASICs) or field programmable gate arrays (FPGAs) can be applied to the processing circuits.

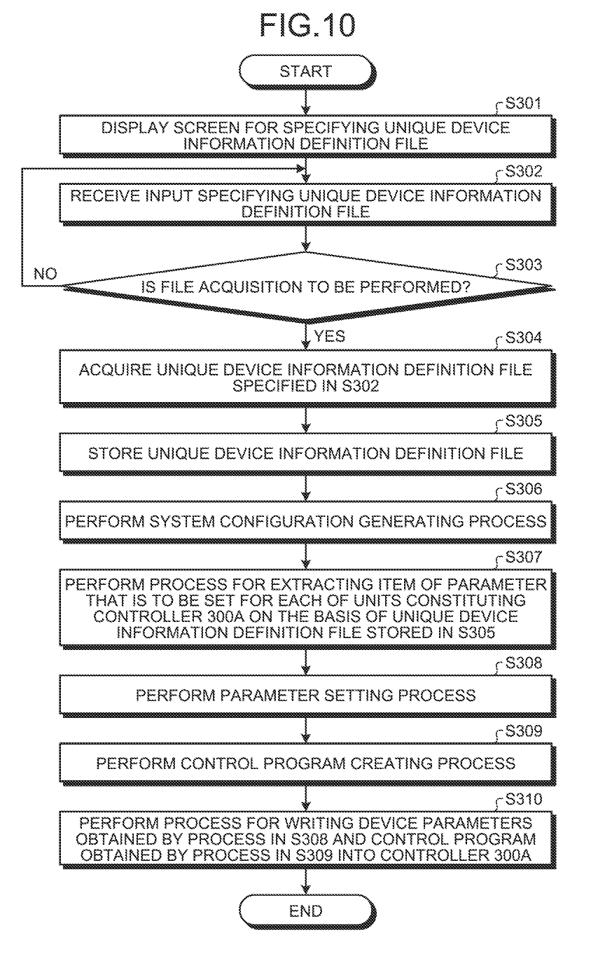

FIG. 10 is a flowchart illustrating an example of processing by the system design supporting device according to the first embodiment. A flow of processing performed by the system design supporting device 200A will be explained below. FIG. 10 illustrates a flow of processing in which the system design supporting device 200A acquires, from a plurality of unique device information definition files stored in the cloud server 10, a unique device information definition file corresponding to each of a plurality of units making up a controller that is to be designed, and sets device parameters.

As illustrated in FIG. 10, the system design supporting device 200A displays a screen for specifying a unique device information definition file (see FIG. 8) (step S301).

Subsequently, the system design supporting device 200A receives an input specifying a unique device information definition file on the screen displayed in step S301 (step S302).

Subsequently, the system design supporting device 200A determines whether or not to perform file acquisition (step S303). Specifically, the system design supporting device 200A determines whether an operation on the file acquisition button 54 illustrated in FIG. 8 is performed.

If the result of the determination indicates that the file acquisition is not to be performed (step S303, No), the system design supporting device 200A returns to the processing in step S302 described above. Conversely, if the result of the determination indicates that the file acquisition is to be performed (step S303, Yes), the system design supporting device 200A acquires from the cloud server 10 the unique device information definition file specified in step S302 (step S304). Thus, unlike the related art, the system design supporting device 200A need not receive in advance registration of the unique device information definition file corresponding to the controller that is to be provided with settings. Rather, as necessary, the system design supporting device 200A can acquire from the cloud server 10 the unique device information definition file specified on the screen.

Subsequently, the system design supporting device 200A stores the unique device information definition file acquired in step S304 (step S305).

Subsequently, the system design supporting device 200A performs a system configuration generating process for the controller 300A (step S306).

Subsequently, on the basis of the unique device information definition file stored in step S305, the system design supporting device 200A performs a process for extracting the item of the parameter that is to be set for each of the units making up the controller 300A (step S307).

Subsequently, the system design supporting device 200A performs a parameter setting process (step S308).

Subsequently, the system design supporting device 200A performs a control program creating process for the controller 300A (step S309).

Subsequently, the system design supporting device 200A performs a process for writing into the controller 300A the device parameters obtained by the process in step S308 and the control program obtained by the process in step S309 (step S310), and terminates the processing illustrated in FIG. 10.

As described above, in the first embodiment, the system design supporting device 200A acquires, from a plurality of unique device information definition files stored in the cloud server 10, a unique device information definition file corresponding to each of a plurality of units making up the controller 300A that to be designed, and sets device parameters. Thus, according to the first embodiment, a database in which unique device information definition files are recorded need not be registered in advance in a system design supporting device, and a user of the system design supporting device can acquire a unique device information definition file from the cloud server 10 as necessary when conducting system design. In addition, the cloud server 10 manages the unique device information definition files corresponding to all the controllers together. Thus, according to the first embodiment, management of all the parameters can be easily conducted. In addition, according to the first embodiment, the system design supporting device 200A need not register the unique device information definition files in advance, which enables efficient use of storage areas of a storage unit without providing storage areas for storing the unique device information definition files in the storage unit. In addition, since a latest unique device information definition file can be acquired from the cloud server 10, the system setting supporting device 200A can set, on the basis of the latest unique device information definition file, parameters of the controller that is to be controlled.

In the first embodiment, the system design supporting device 200A provides a screen displaying a list of file names of unique device information definition files that can be specified, and receives specification of a unique device information definition file on the screen. Thus, according to the first embodiment, a user of a system design supporting device can easily perform the operation of specifying a file from a plurality of unique device information definition files, and parameters for each controller can easily be set.

In the first embodiment, data storages areas of the file storage unit 11 of the cloud server 10 and other storage units may be physically or virtually separated into areas that can be accessed by users of the respective system design supporting devices such as the system design supporting devices 200A, 200B, and 200C; and areas that can be individually accessed by each of the users of the respective system design supporting devices. Each of the users of the respective system design supporting devices may perform an authentication process using a user ID, a password, and the like.

In the first embodiment, each of the storage areas of the file storage unit 11 of the cloud server 10 physically or virtually separated from one another may be provided for each company that provides unique device information definition files associated with controllers. In this case, each company may perform the registration process and the updating process of the unique device information definition files on its own.

In the first embodiment, the system design supporting devices such as the system design supporting devices 200A, 200B, and 200C may each have data necessary for displaying, on the screen illustrated in FIG. 8, the list of the file names of the unique device information definition files that can be specified by the user P1. The system design supporting devices such as the system design supporting devices 200A, 200B, and 200C may each acquire from the cloud server 10 data necessary for displaying on the screen illustrated in FIG. 8 the list of the names of the unique device information definition files that can be specified by the user P1. The cloud server 10 may have in advance summary data, which summarize the list of the file names and the like, as data necessary for displaying the list of the file names of the unique device information definition files. The summary data may be in any format in which users of the system design supporting devices can specify a file name. The cloud server 10 may provide the summary data in response to a request from each system design supporting device.

### Second Embodiment

In the first embodiment described above, an example in which a system design supporting device acquires a unique device information definition file from the cloud server 10 as necessary and sets parameters for the controller to be controlled by using the unique device information definition file has been explained. A second embodiment described below provides an example in which a controller, instead of a system setting supporting device, acquires a unique device information definition file from the cloud server 10 and sets parameters.

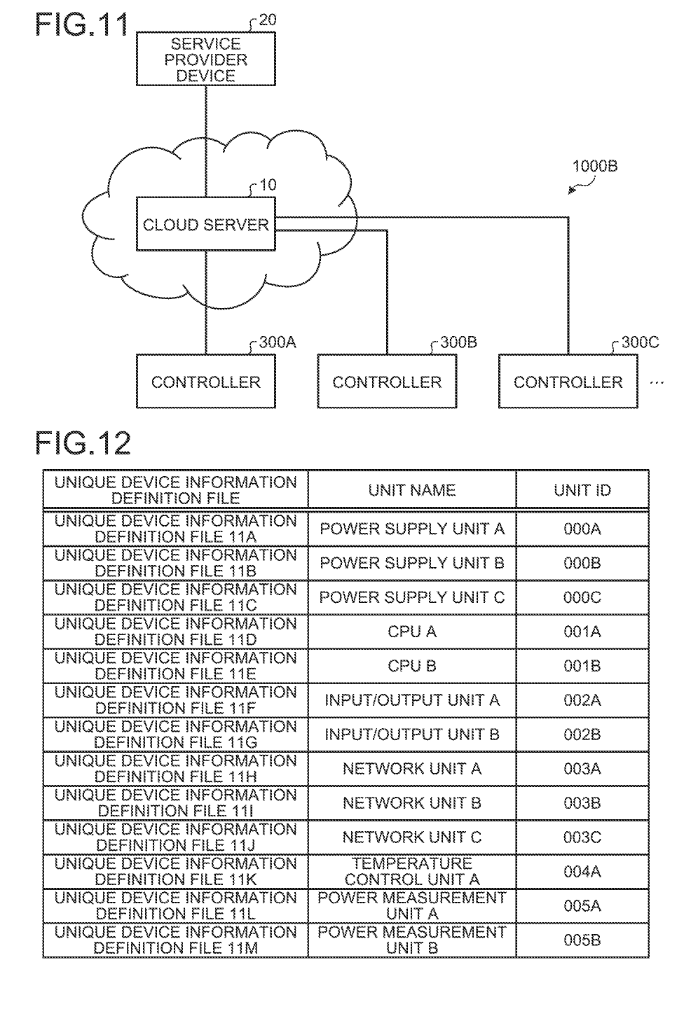

FIG. 11 is a diagram illustrating an example of a configuration of a control system according to the second embodiment. As illustrated in FIG. 11, a control system 1000B according to the second embodiment includes a cloud server 10, a service provider device 20, and controllers 300A, 300B, and 300C. The controllers 300A, 300B, and 300C are each connected to the cloud server 10 via a network such that the controllers 300A, 300B, and 300C can communicate with the cloud server 10.

The file storage unit 11 of the cloud server 10 according to the second embodiment stores the unique device information definition files 11A to 11M in which information corresponding to any ones of a plurality of units making up the controllers 300A, 300B, and 300C is recorded. The file storage unit 11 further stores IDs that are identifiers uniquely assigned to the respective unique device information definition files 11A to 11M, as illustrated in FIG. 12. FIG. 12 is a table illustrating association between unique device information definition files, units, and unit IDs according to the second embodiment.

The cloud server 10 according to the second embodiment has a functional configuration basically similar to that in the first embodiment, but is different therefrom in the following respects. The file transmission unit 12a of the cloud server 10 according to the second embodiment controls transmission of unique device information definition files to the controllers 300A, 300B, and 300C via the communication processing unit 13. Specifically, upon receiving from the controller 300A a request for acquiring unique device information definition file, the file transmission unit 12a acquires a unit ID included in the acquisition request. Subsequently, the file transmission unit 12a reads from the file storage unit 11 a unique device information definition file corresponding to the acquired unit ID. Subsequently, the file transmission unit 12a transmits the unique device information definition file read from the file storage unit 11, to the controller 300A, which is the source of the acquisition request, via the communication processing unit 13. Upon receiving from the controller 300B or the controller 300C a request for acquiring a unique device information definition file, the file transmission unit 12a also performs processing in the procedures similar to those of the processing that the file transmission unit 12a performs upon receiving from the above controller 300A a request for acquiring a unique device information definition file.

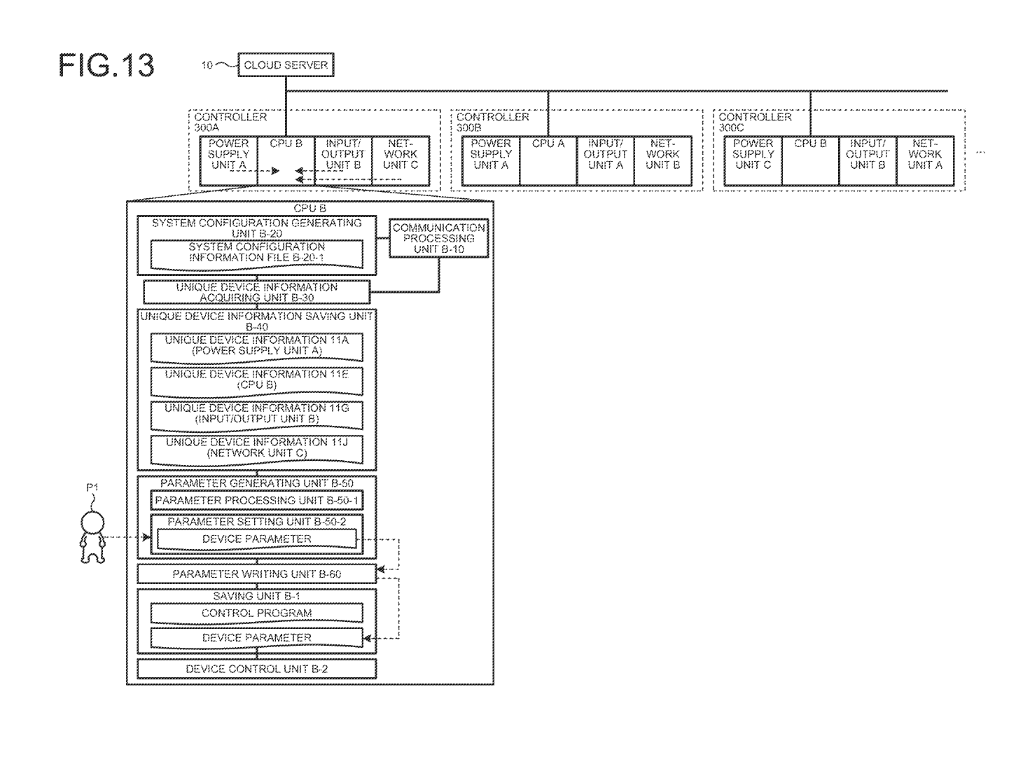

FIG. 13 is a diagram illustrating an example of a functional configuration of a controller according to the second embodiment. Since the controllers 300A, 300B, and 300C according to the second embodiment have configurations basically similar to one another, the controller 300A will be taken from among the controllers 300A, 300B, and 300C and the functional configuration of the controller 300A will be described below.

As illustrated in FIG. 13, the controller 300A according to the second embodiment is connected to the cloud server 10 via a network in a state in which the controller 300A can communicate with the cloud server 10.

As illustrated in FIG. 13, the controller 300A includes a power supply unit A, a CPU B, an input/output unit B, and a network unit C. The CPU B includes a communication processing unit B-10, a system configuration generating unit B-20, a unique device information acquiring unit B-30, a unique device information saving unit B-40, a parameter generating unit E-50, a parameter writing unit B-60, a saving unit B-1, and a device control unit B-2.

The communication processing unit B-10 controls communication with the cloud server 10.

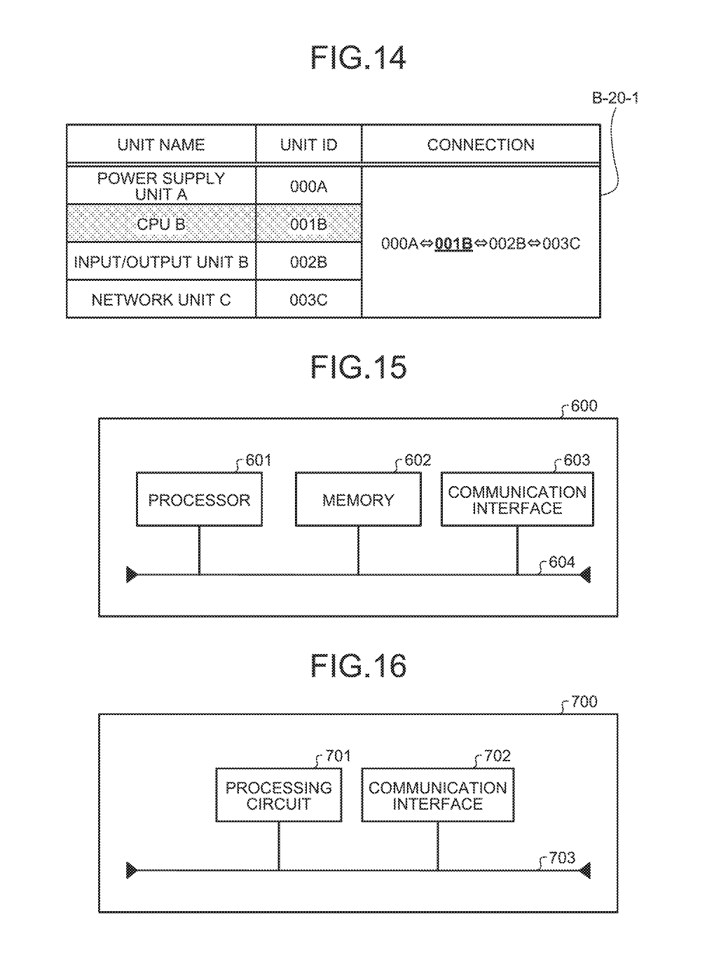

The system configuration generating unit B-20 creates a system configuration information file B-20-1 in which the system configuration information on the controller 300A is recorded. Specifically, when the system of the controller 300A is powered on and started, the system configuration generating unit B-20 collects from the other units of the controller 300A information on the other units, and creates a system configuration information file B-20-1 on the basis of the collected information and the information on the CPU B. FIG. 14 is a diagram illustrating an example of the system configuration information file according to the second embodiment. The system configuration information file B-20-1 illustrated in FIG. 14 has recorded therein a correspondence between unit names of the units of the controller 300A and unit IDs that are identifiers each uniquely assigned to the corresponding one of the units. The system configuration information file B-20-1 illustrated in FIG. 14 further includes information on connections among the units. In the example illustrated in FIG. 14, “power supply unit A”, “CPU B”, “input/output unit B”, and “network unit C” are recorded as the unit names. In addition, in the example illustrated in FIG. 14, the unit ID “000A” of the power supply unit A, the unit ID “001B” of the CPU B, the unit ID “002B” of the input/output unit B, and the unit ID “003C” of the network unit C are each recorded in correspondence to the associated unit name. In the example illustrated in FIG. 14, information on the connections among the units of the controller 300A is recorded in terms of the unit IDs of the units. The unit name and the unit ID of the CPU B, which is the subject that creates the system configuration information file B-20-1, may be recorded in advance in the system configuration information file B-20-1.

Referring to the correspondence recorded in the system configuration information file B-20-1, the unique device information acquiring unit B-30 acquires from the cloud server 10 each of the unique device information definition files that is tied to the corresponding one of a plurality of unit. IDs included in the system configuration information file B-20-1. The unique device information acquiring unit B-30 stores the acquired unique device information definition files in the unique device information saving unit B-40. Specifically, the unique device information acquiring unit B-30 acquires the system configuration information file B-20-1 from the system configuration information generating unit B-20, and acquires the unit ID corresponding to the associated one of the units included in the system configuration information file B-20-1. Subsequently, the unique device information acquiring unit B-30 inserts the acquired unit IDs in a request for acquiring a unique device information definition file, and transmits the request to the cloud server 10. Subsequently, upon receiving the unique device information definition file from the cloud server 10, the unique device information acquiring unit E-30 stores the received unique device information definition file in the unique device information saving unit B-40. Upon receiving a notification that a writing process is completed from the parameter writing unit B-60, the unique device information acquiring unit B-30 deletes the unique device information definition file stored in the unique device information saving unit. B-40.

The unique device information saving unit B-40 stores the unique device information definition file that the unique device information acquiring unit B-30 acquires from the cloud server 10.

The parameter generating unit B-50 includes a parameter processing unit B-50-1 and a parameter setting unit B-50-2.

On the basis of the unique device information definition file stored in the unique device information saving unit B-40, the parameter processing unit B-50-1 performs a process for extracting each item of the parameter that is to be set for each of a plurality of units constituting the controller 300A.

The parameter setting unit B-50-2 performs a parameter setting process. Specifically, the parameter setting unit B-50-2 sets a device parameter that is a parameter value input by the user P1 for each item of the parameter that the parameter processing unit B-50-1 extracts for each of the units.

The parameter writing unit B-60 performs a process for writing into the saving unit B-1 the device parameters set by the parameter generating unit B-50. Upon completion of the writing of the device parameters set by the parameter setting unit B-50-2 into the saving unit B-1, the parameter writing unit B-60 notifies the unique device information acquiring unit B-30 of the completion of the writing process.

The saving unit B-1 stores the device parameters written by the parameter writing unit B-60. The saving unit B-1 stores in advance control programs for controlling the operations of the power supply unit A, the input/output unit B, and the network unit C, all of which make up the controller 300A. Using the control program and the devices parameters stored in the saving unit B-1, the device control unit B-2 controls the operations of the power supply unit A, the input/output unit B, and the network unit C of the controller 300A.

An example of a computer that implements controls similar to various controls of the controllers according to the second embodiment will be described with reference to FIGS. 15 and 16. FIGS. 15 and 16 are diagrams illustrating examples of a hardware configuration of a controller according to the second embodiment.

A computer 600 illustrated in FIG. 15 includes a processor 601, a memory 602, and a communication interface 603. The processor 601, the memory 602, and the communication interface 603 are connected to one another via a bus 604. Part of the memory 602 corresponds to, for example, the unique device information saving unit B-40 included in the CPU B of the controller 300A. The communication interface 603 corresponds to, for example, the communication processing unit B-10 included in the CPU B of the controller 300A.

The functions provided by the controller described in the second embodiment are implemented by, for example, the computer 600 illustrated in FIG. 15 by software, firmware, or a combination of software and firmware. The software and firmware are described as programs corresponding to, for example, the functions provided by the system configuration generating unit B-20, the unique device information acquiring unit B-30, the parameter generating unit B-50, the parameter writing unit B-60, and the device control unit B-2 of the controller 300A, and stored in the memory 602. The memory 602 may be a volatile or nonvolatile semiconductor memory such as a RAM, a ROM, a flash memory, an erasable PROM (EPROM), or an electrically EPROM (EEPROM), a magnetic disk, a flexible disk, an optical disk, a compact disk, a mini disk, a digital video disk, or the like.

By reading and executing programs stored in the memory 602, the CPU 601 implements the functions provided by the system configuration generating unit B-20, the unique device information acquiring unit B-30, the parameter generating unit B-50, the parameter writing unit B-60, and the device control unit B-2 of the controller 300A. The CPU 601 may be another computing device such as a microprocessor, a microcomputer, a processor, or a digital signal processor (DSP).

In a case where the functions provided by the controller described in the second embodiment are implemented by software or the like, the computer 600 includes the memory 602 for storing programs that result in execution of processes including steps of: automatically acquiring, from a plurality of unique device information definition files stored in the cloud server 10, unique device information definition files each corresponding to the associated one of the units of the controller 300A; and setting the device parameters.

A computer 700 illustrated in FIG. 16 includes a processing circuit 701 and a communication interface 702. The processing circuit 701 and the communication interface 702 are connected to each other via a bus 703. The processing circuit 701 implements the functions provided by, for example, the communication processing unit B-10, the system configuration generating unit B-20, the unique device information acquiring unit B-30, the unique device information saving unit B-40, the parameter generating unit B-50 the parameter writing unit B-60, the saving unit B-1, and the device control unit B-2, all of which make up the CPU B of the controller 300A. The communication interface 702 corresponds to, for example, the communication processing unit B-10 of the CPU B of the controller 300A.

In a case where the functions provided by the controller described in the second embodiment are implemented by dedicated hardware, the processing circuit 701 may be configured to individually implement the functions provided by the communication processing unit B-10, the system configuration generating unit B-20, the unique device information acquiring unit B-30, the unique device information saving unit B-40, the parameter generating unit B-50, the parameter writing unit B-60, the saving unit B-1, and the device control unit B-2, or to collectively implement the functions. The processing circuit 701 may be a single circuit, a composite circuit, a programmed processor, a parallel-programmed processor, an ASIC, an FPGA, or a combination thereof, for example.

As described above, the functions provided by the controller according to the second embodiment may be implemented by the computer 600 illustrated in FIG. 15 by software, firmware, or a combination of software and firmware, or by dedicated hardware like the computer 700 illustrated in FIG. 16.

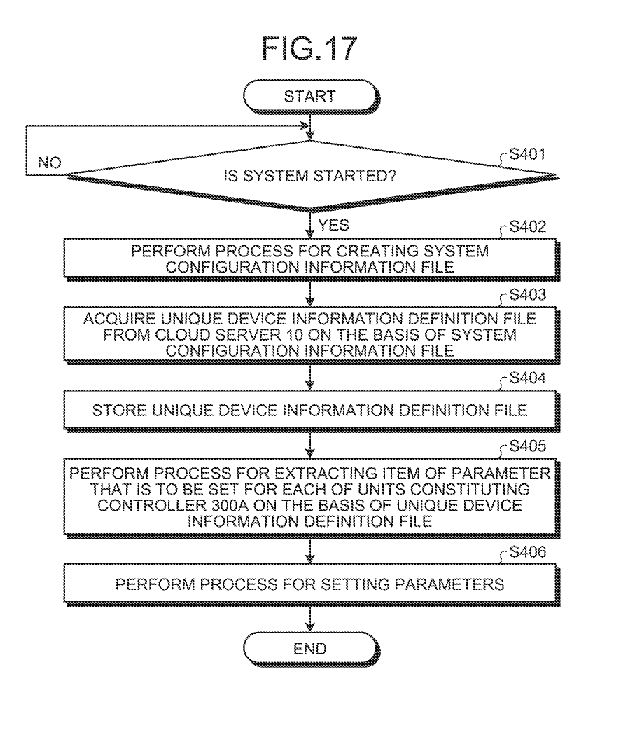

FIG. 17 is a flowchart illustrating an example of processing of a controller according to the second embodiment. A flow of processing performed by the controller 300A will be described below. FIG. 17 illustrates a flow of processing in which the controller 300A acquires, from a plurality of unique device information definition files stored in the cloud server 10, a unique device information definition file corresponding to each of a plurality of units constituting the controller 300A, and sets the device parameters.

As illustrated in FIG. 17, the controller 300A determines whether or not the system is started (step S401).

If the result of the determination indicates that the system is not started (step S401, No), the controller 300A repeats the determination in step S401.

If the result of the determination indicates that the system is started (step S401, Yes), the controller 300A performs a process for creating a system configuration information file (step S402). Specifically, the CPU B of the controller 300A collects, from the other units of the controller 300A, information on the other units, and creates a system configuration information file B-20-1 (see FIG. 14) on the basis of the collected information and the information on the CPU B.

Subsequently, the controller 300A acquires unique device information definition files from the cloud server 10 on the basis of the system configuration information file (step S403). Specifically, the CPU B of the controller 300A acquires the unit ID corresponding to the associated one of the units included an the system configuration information file B-20-1, inserts the acquired unit ID in a request for acquiring a unique device information definition file, and transmits the request to the cloud server 10 via the communication processing unit B-10, such that the CPU B acquires a unique device information definition file from the cloud server 10. Thus, unlike the related art, the controller 300A need not receive in advance registration of the unique device information definition file corresponding to the controller that is to be provided with the settings. Rather, as necessary, the controller 300A can acquire from the cloud server the unique device information definition file corresponding to each of the units of the controller 300A, on the basis of the system configuration information file B-20-1.

Subsequently, the controller 300A stores the unique device information definition file acquired from the cloud server 10 (step S404).

Subsequently, on the basis of the unique device information definition file, the controller 300A performs a process for extracting each of items of parameters that is to be set for each of the un of the controller 300A (step S405).

Subsequently, the controller 300A performs a process for setting the parameters (step S406), and terminates the processing illustrated in FIG. 17. Specifically, the CPU B of the controller 300A sets a device parameter that is a parameter value input by the user P1 for each of the items of parameters extracted for each of the units. The CPU B writes the set parameters into the saving unit B-1.

As described above, in the second embodiment, the controller 300A automatically collects information on a plurality of units of the controller 300A, automatically acquires, from a plurality of unique device information definition files stored in the cloud server 10, a unique device information definition file corresponding to each of the units on the basis of the collected information, and sets the device parameters. Thus, according to the second embodiment, the operation for specifying a unique device information definition file as in the first embodiment is not needed, thereby further facilitates setting of parameters for each control device. In addition, according to the second embodiment, the controller 300A need not register the unique device information definition files in advance, thereby enabling efficient use of storage areas of a storage unit without providing storage areas for storing the unique device information definition files in the storage unit. Furthermore, since a latest unique device information definition file can be acquired from the cloud server 10, the controller 300A can set parameters of the units on the basis of the latest unique device information definition file.

### Third Embodiment

Although the first embodiment described above gives an example in which the system design supporting device 200A retrieves from the cloud server 10 a unique device information definition file specified in the system design supporting device 200A and performs system design (setting of parameters, creation of control programs, and the like), the present invention is not limited to this example. For example, system design may be performed in the cloud server 10 instead of the system design supporting device 200A. In a third embodiment below, processing in this case will be explained.

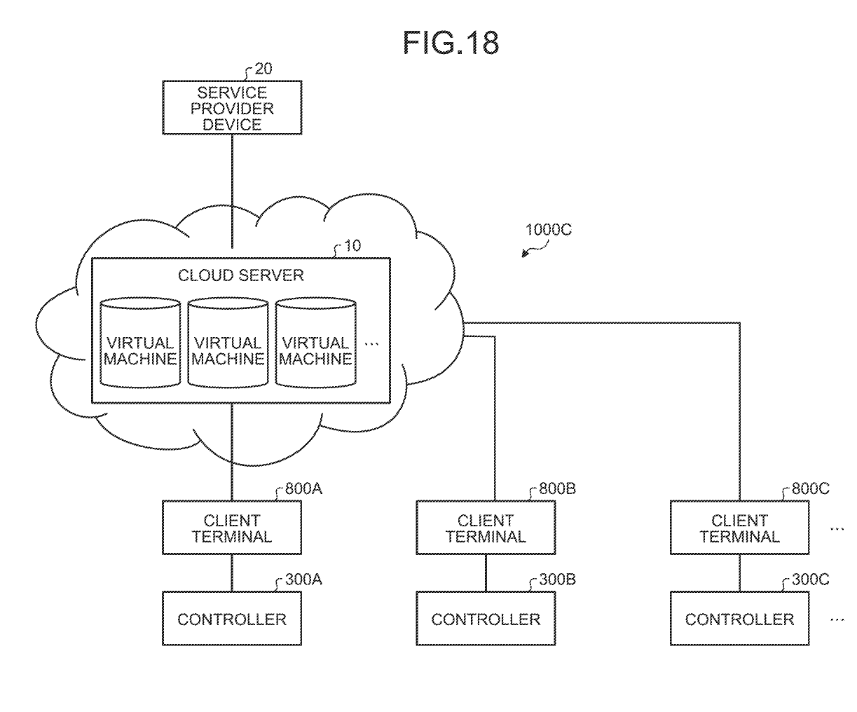

FIG. 18 is a diagram illustrating an example of a configuration of a control system according to the third embodiment. As illustrated in FIG. 18, a control system 1000C according to the third embodiment includes a cloud server 10, a service provider device 20, client terminals 800A, 800B, and 800C (hereinafter referred to as “client terminals” as appropriate), and controllers 300A, 300B, and 300C (hereinafter referred to as “controllers” as appropriate). Each of the client terminals is connected to the cloud server 10 via a network such that the client terminal can communicate with the cloud server 10. In addition, the client terminal 800A is connected to the controller 300A such that the client terminal 800A can communicate with the controller 300A. Similarly, the client terminal 800B is connected to the controller 300B such that the client terminal 800B can communicate with the controller 300B. Similarly, the client terminal 800C is connected to the controller 300C such that the client terminal 800C can communicate with the controller 300C.

The cloud server 10 can provide the client terminals with virtual desktops (VDs) by connecting virtual machines on the cloud server 10 to the client terminals. The virtual desktop according to the third embodiment is implemented by a virtual machine provided with a general-purpose basic program for providing virtual desktop environment for a client terminal, an application for performing system design, and the like. The cloud server 10 manages the virtual desktops, virtual environment, sessions, and data storage.

The client terminals 800A, 800B, and 800C are terminals operated by users of the client terminals connected to the cloud server 10 to perform system design. The system design supporting devices 200A, 200B, and 200C described in the previous embodiment may be used as the client terminals.

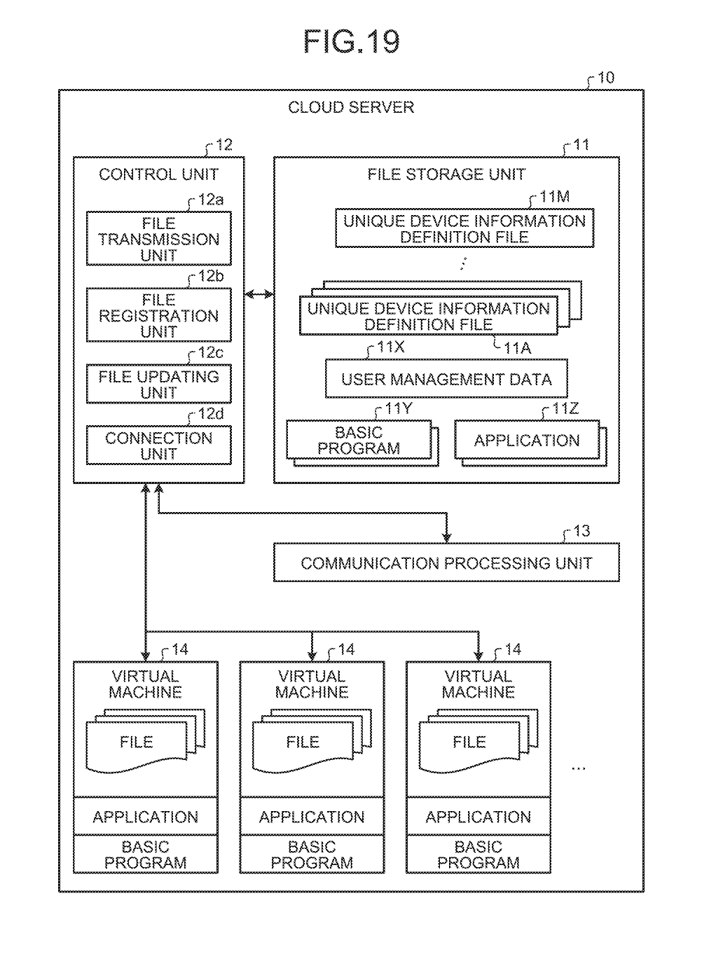

FIG. 19 is a diagram illustrating an example of a functional configuration of the cloud server according to the third embodiment. As illustrated in FIG. 19, the cloud server 10 includes a file storage unit 11, a control unit 12, a communication processing unit 13, and virtual machines 14. The cloud server 10 according to the third embodiment has a functional configuration basically similar to that in the first embodiment, but is different therefrom in the functions and the like for implementing processes according to the third embodiment.

The file storage unit 11 stores the unique device information definition files 11A to 11M, user management data 11X, basic programs 11Y, and applications 11Z unique device information definition files 11A to 11M are files similar to the unique device information definition files 11A to 11M (see FIG. 3) described in the first embodiment.

The user management data 11X are data for managing a correspondence between path information of a client terminal and path information of a virtual desktop, for each of the users of the client terminals that perform system design. The user management data 11X manages this correspondence between the client-terminal path information and the virtual-desktop path information, using the virtual desktops provided by the cloud server 10. The path information includes, for example, a user ID, a password, the IP address of the client terminal, the IP address of the virtual machine 14, a basic program that is to be used, and data relating to an application that is to be used.

The basic programs 11Y are general-purpose programs for controlling the operation of the virtual machines 14. The basic programs 11Y include general-purpose programs for providing virtual desktop environment for the client terminals. The basic programs 11Y may include “VMware Horizon (registered trademark)”, “Cintrix XenDesktop (registered trademark)”, “Microsoft VDT (registered trademark)”, “Windows (registered trademark)”, and the like.

The applications 11Z are programs for the users of the client terminals to perform system design on the virtual desktops. The applications 11Z include functions for performing various functions implemented by the system design supporting devices in the first embodiment. Specifically, the applications 11Z can provide a function of displaying a screen displaying a list of the file names of the unique device information definition files on a client terminal, a function of reading the unique device information definition file selected by a user of a client terminal, a function of displaying, on a client terminal, a parameter setting screen for receiving from a user of the client terminal an input of a parameter value for each of items of parameters extracted for each of units of a controller, a function of setting a device parameter that is a parameter value input from a client terminal via the parameter setting screen, a function of displaying on the client terminal a program creation screen for receiving from a user of a client terminal an operation of editing source codes for controlling a controller, and a function of creating a control program by compiling source codes written by a user of a client terminal.

The control unit 12 has functions basically similar to those in the first embodiment, but is different therefrom including a connection unit 12d.

When authentication of a client terminal that has transmitted a connection request is successful, the connection unit 12d refers to the user management data 11X, and connects the client terminal to a virtual machine 14. The connection unit 12d refers to the user management data 11X, and transmits, to the client terminal, parameters set by the user of the client terminal on the virtual desktop and a control program created by the user of the client terminal on the virtual desktop.

The communication processing unit 13 has functions similar to those in the first embodiment described above.

The virtual machine 14 implements a virtual desktop that is to be provided for the client terminal. On the basis of the user management data 11X, the virtual machine 14 loads onto resources of the cloud server 10 the basic program 11Y, the application 11Z, and files etc. corresponding to the user of the client terminal having logged in, and thus provides virtual desktop environment corresponding to the client terminal.

The hardware configuration of the cloud server 10 can be implemented by the hardware configuration of the cloud server 10 according to the first embodiment (see FIG. 4). The processor 401 operates accordance with results of execution of instructions included in a program, thereby implementing various controls corresponding to, for example, the functions provided by the connection unit 12d in addition to implementing the controls corresponding to the functions described in the first embodiment.

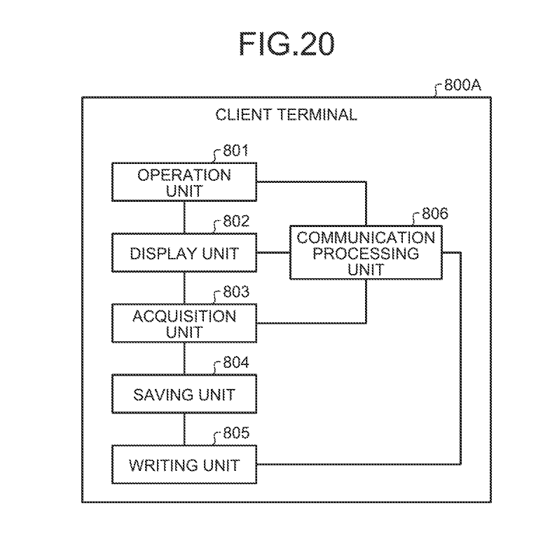

FIG. 20 is a diagram illustrating an example of a functional configuration of the client terminals according to the third embodiment. The client terminal 800A will be taken as an example below. As illustrated in FIG. 20, the client terminal 800A includes an operation unit 801, a display unit 802, an acquisition unit 803, a saving unit 804, a writing unit 805, and a communication processing unit 806. The operation unit 801 receives operation of the user of the client terminal 800A. The display unit 802 displays a virtual desktop provided from the cloud server 10. The acquisition unit 803 acquires parameters and a control program received from the cloud server 10. The saving unit 804 stores the parameters and the control program acquired by the acquisition unit 803. The writing unit 805 reads the parameters and the control program from the saving unit 804, and writes the parameters and the control program into the controller 300A. The communication processing unit 806 controls communication with the cloud server 10.

The hardware configuration of the client terminal 800A can be implemented by the hardware configuration similar to that of the computer 500 (see FIG. 9) as the system design supporting device according to the first embodiment described above, for example. For example, the processor 501 reads and executes programs stored in the ROM 503, thereby implementing various controls corresponding to the respective functions provided by the operation unit 801, the display unit 802, the acquisition unit 803, the saving unit 804, the writing unit 805, and the communication processing unit 806 of the client terminal 800A.

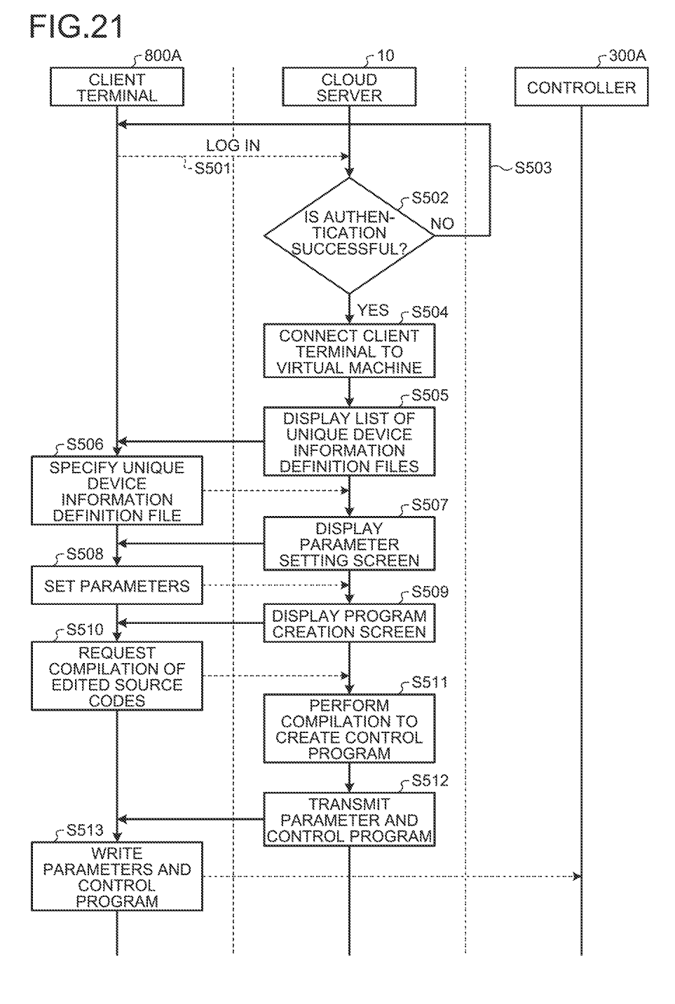

FIG. 21 explains an example of processing by the control system according to the third embodiment. FIG. 21 is a diagram illustrating an example of processing by the control system according to the third embodiment. In the example illustrated in FIG. 21, processing performed by the client terminal 800A, the cloud server 10, and the controller 300A will be explained.

As illustrated in FIG. 21, the client terminal 800A transmits a login request to the cloud server 10 (step S501). The login request includes, for example, a user ID and a password.

The cloud server 10 performs login authentication in response to the login request from the client terminal 800A (step S502).

If the login authentication results in a failure (step S502, No), the cloud server 10 transmits a notification of the failure of the login authentication to the client terminal 800A (step S503).

If the login authentication is successful (step S502, Yes), the cloud server 10 connects the client terminal 800A to the virtual machine 14 (step S504). As a result of step S504, virtual desktop environment is provided for the client terminal 800A to thereby allow the user of the client terminal 800A to perform system design on the client terminal 800A.

After connecting the client terminal 800A to the virtual machine 14, the cloud server 10 displays a list of unique device information definition files (step S505). As a result of step S505, the list of the unique device information definition files is displayed on the display unit 802 of the client terminal 800A.

The client terminal 800A specifies a unique device information definition file (step S506). In step S506, the user of the client terminal 800A can perform operation of specifying a unique device information definition file on the virtual desktop provided by the cloud server 10.

After a unique device information definition file is specified by the client terminal 800A, the cloud server 10 displays a parameter setting screen (step S507). As a result or step S507, the parameter setting screen for receiving, from the user of the client terminal, an input of a parameter value for each of items of parameters extracted for each of the units of the controller 300A is displayed on the display unit 802 of the client terminal 800A.

The client terminal 800A sets parameters (step S508). In step S508, the user of the client terminal 800A can input a parameter value for each of the items of the parameters extracted for each of the units of the controller 300A on the virtual desktop provided by the cloud server 10.

After the client terminal 800A sets the parameters, the cloud server 10 displays a program creation screen (step S509). As a result of step S509, the program creation screen for receiving from the user of the client terminal 800A an operation of editing source codes for controlling the controller 300A is displayed on the display unit 802 of the client terminal 800A.

The client terminal 800A requests a compilation of the edited source codes (step S510). In step S510, the user of the client terminal 800A can perform the operation of editing the source codes for controlling the controller 300A on the virtual desktop provided by the cloud server 10.

In response to the compilation request transmitted from the client terminal 800A, the cloud server 10 complies the source codes edited by the client terminal 800A and creates a control program (step S511).

After creating the control program, the cloud server 10 transmits the parameters and the control program to the client terminal 800A (step S512).

The user of the client terminal 800A writes into the controller 300A the parameters and the control program received from the cloud server 10 (step S513), thereby terminating the processing illustrated in FIG. 21.

The third embodiment described above gives an example in which the cloud server 10 provides a virtual desktop for the client terminal 800A so that the user of the client terminal 800A can set the parameter for each of the units of the controller 300A and perform the operation of editing source codes for controlling the controller, on the cloud server 10. This enables the client terminal, which has at least a communication function, an input function, and a display output function, to execute a familiar application on a familiar desktop to perform setting of parameters and editing of programs without being limited by time and place.

While the cloud server 10 provides services of so-called Desktop as a Service (DaaS) for the client terminals in the third embodiment described above, the cloud server is not limited to this example, and may employ a so-called thin client system as long as setting of parameters and editing of programs can be performed.

While the cloud server 10 provides the program creation screen for the client terminal via the virtual desktop in the third embodiment described above, the cloud server may further provide the client terminal with an application program interface (API) relating to system design as one of the applications 11Z. The user of the client terminal can easily edit a control program by reading and using the API in performing an operation of editing a program.

in the third embodiment described above, the physical configuration of the cloud server 10 may be such that resources and components for providing virtual desktops to the client terminals as necessary for management of virtual desktops, management of virtual environment, management of sessions, management of data storage, and the like are physically distributed or integrated.

The configurations presented in the embodiments above are examples of the present invention, and can be combined with other known technologies or can be partly omitted or modified without departing from the scope of the present invention.

### REFERENCE SIGNS LIST

1 network; 10 cloud server; 20 service provider device; 200A, 2005, 200C system design supporting device; 300A, 300B, 300C controller; 400, 500, 600, 700 computer; 800A, 800B, 800C client terminal; 1000A, 10008, 1000C control system.

1. A system design supporting device connected to a server and a controller for communication with the server and the controller, the system design supporting device comprising:
file specification receiving circuitry to receive specification of a unique device information definition file from a plurality of unique device information definition files stored in the server;
file acquiring circuitry to acquire, from the server, the unique device information definition file whose specification is received by the file specification receiving circuitry; and
parameter setting circuitry to set a parameter for controlling operation of a unit of the controller, on the basis of the unique device information definition file.

2. The system design supporting device according to claim 1, further comprising a display, wherein
the file specification receiving circuitry displays, on the display, a screen containing list information showing a list of the specifiable unique device information definition files, and receives the specification of the unique device information definition file from the displayed list information, and
the file acquiring circuitry acquires, from the server, the unique device information definition file whose specification is received by the file specification receiving circuitry.

3. The system design supporting device according to claim 1, wherein the parameter setting circuitry performs a process for extracting an item of the parameter corresponding to the unit of the controller, on the basis of the unique device information definition file.

4. The system design supporting device according to claim 1, wherein the server is a cloud server.

5-9. (canceled)

10. The system design supporting device according to claim 2, wherein the server is a cloud server.

11. The system design supporting device according to claim 3, wherein the server is a cloud server.

12. The system design supporting device according to claim 2, wherein the screen is an operation screen,
the operation screen displays file names of a plurality of unique device information definition files stored in the server,
the operation screen comprising:
check boxes provided on a file-name-by-file-name basis and adjacent to each other, to receive operation of specifying the unique device information definition files; and
a file acquisition button to receive an instruction to perform a process for acquiring, from the server, the unique device information definition files whose specification is received by the check boxes.

13. A method performed by a system design supporting device connected to a server and a controller for communication with the server and the controller, the method comprising:
receiving specification of a unique device information definition file from a plurality of unique device information definition files stored in the server;
acquiring, from the server, the unique device information definition file whose specification is received; and
setting a parameter for controlling operation of a unit of the controller, on the basis of the unique device information definition file.

14. A non-transitory computer readable medium for causing a system design supporting device, connected to a server and a controller for communication with the server and the controller, to perform:
receiving specification of a unique device information definition file from a plurality of unique device information definition files stored in the server;
acquiring, from the server, the unique device information definition file whose specification is received; and
setting a parameter for controlling operation of a unit of the controller, on the basis of the unique device information definition file.
